(19) United States
(12) Patent Application Publication
(10) Pub. No.: US 2014/0012498 A1
(43) Pub. Date: Jan. 9, 2014

(54) Informed Traveler Program and Application

(71) Applicants: Thomas F. Gustafson, Wellington, FL (US); Naphtali Rishe, Miami Beach, FL (US); Ramon Trias, Miami, FL (US); Kenneth Stapleton, Bay Harbor Island, FL (US)

(72) Inventors: Thomas F. Gustafson, Wellington, FL (US); Naphtali Rishe, Miami Beach, FL (US); Ramon Trias, Miami, FL (US); Kenneth Stapleton, Bay Harbor Island, FL (US)

(21) Appl. No.: 13/847,024

(22) Filed: Mar. 19, 2013

Related U.S. Application Data
(60) Provisional application No. 61/612,932, filed on Mar. 19, 2012.

(51) Int. Cl. G01C 21/34

(52) U.S. Cl. CPC G01C 21/3423
USPC 701/468; 701/537

(57) ABSTRACT

A method of informed, multi-modal travel from one or more potential routes to a defined destination includes using real-time travel-related data relative to one or more inputs of present traffic flow, emergency events, special community events, weather, historic traffic-affecting trends, and parking conditions at an informed traveler's destination; providing at least one output of using an historical database of the above real time data; generating a spatial analysis of real-time traffic flow and other traffic data; applying predictive and analytic models having rule-based constraints to selective outputs of said steps; providing guidance as to time allowed for and directions to make intermodal transfers; accounting for personal and medical information supplied by the traveler; confirming authorized users by identity confirmation and management; and providing user and management wireless access portals to the informed traveler.

### REFERENCE TO RELATED APPLICATION

This application claims the benefit under 35 USC 119 (e) of Provisional Patent Application Ser. No. 61/612,932, filed Mar. 19, 2012, and the same is incorporated herewith in its entirety.

### BACKGROUND OF THE INVENTION

The Informed Traveler Program and Application (ITPA) employs a smartphone-based interface to provide personalized, timely information and advice regarding the most efficient and cost-effective travel paths for users consistent with traveler destination scheduling requirements. This includes information about whether to use transit, delay the start of a trip to avoid congestion, or take an alternate route to avoid rush hour, construction, accident or other delays. It takes into account specific user needs and travel or medical limitations when providing travel information and choices. It provides specific guidance as to timing allowed for and directions during intermodal transfers.

ITPA is also predictive in nature, allowing users to make better travel decisions even before they enter their private vehicles. It also offers ITPA users the possibilities of express transit routes and faster parking in “smart” garages associated with the system, as a major time saver. The system works on smart phones and mobile computing devices, and includes audio and visual capabilities similar to standard car GPS devices, but with intelligence behind the system that considers user needs, situational conditions, multimodal and intermodal options, and safety concerns.

This unique and innovative combination of technology and transit is a first-of-its-kind effort that will serve as a model for communities throughout the nation by changing current “stop and go” automotive and metropolitan bus transport as experienced throughout America and the world into “fast and slow” movements by providing expert guidance to support transportation choices so that the informed travelers use passenger trains, fixed-guideway transit, and express buses instead of their car or small truck for most of the longer regional trip segments and changes modes to walking, bicycles, community transit and local buses for the shorter trips segments at the beginning and end of each regional trip.

Further, many local trips are accomplished through an informed traveler choosing to walk and use a bicycle, community transit and/or local bus instead of personal cars or trucks. IPTA thereby enables travelers with both the information and the confidence, through experience based reinforcements arising from continued IPTA use, to delay travel plans, change routes, or take public transit instead of following a reflexive pattern of automotive travel.

For a better understanding of how the ITPA can benefit users, consider the following scenarios:

The Frustrated Employee—Annette is driving from northern Broward County southbound on a congested 1-95 on her way to her Miami-Dade County located university workplace at 8:00 AM. She is a busy Vice President for External Relations and was away from home the entire past week. After a short weekend rest, she is catching up on emails and got a late start from home.

One-third of the way through her commute, ITPA uses real-time traffic information on current conditions, previous conditions, previous outcomes and inputs, combined with Annette's current location and desired destination identified by Annette's smart phone calendar to determine that the various limited access highways and major roadway arterials that would link Annette with her destination are all congested. ITPA calculates the travel time by car and alerts Annette that she will be late to her 9:00 AM appointment on the university's Main Campus. ITPA suggests alternative modes that use public transit and would make her travel faster, easier and less expensive and provides Annette the following information:
1) Congested traffic conditions and estimated arrival time if she stays on the various highway and arterial routes
2) Time and cost benefits of choosing one of several mass transit alternatives
3) Option to reschedule her appointment and wait in place at the next exit by shopping for an upcoming wedding anniversary at an identified retail outlet for that present before resuming her automotive trip

Annette is frustrated because this had been a difficult to schedule interview with the internationally acclaimed weather expert and so she decides to park at the Sheridan Street Tri-Rail Station two exists southward of her current location. This gives her time to change lanes and exit the Sheridan exits on 1-95 and take the Tri-Rail train that ITPA says is scheduled to leave within five minutes after her projected Sheridan Station arrival. ITPS confirms the train is expected to arrive on time.

As Annette arrives at the Sheridan Station, a newly constructed smart garage identifies to ITPA that there is a parking spot that can be reserved on the ground floor and that there are 20 unreserved parking spots on the north side of the fourth floor of the garage. ITPA informs Annette and recommends that she choose the first floor parking spot she can reserve and more quickly walk to the train station; she is carrying a very heavy briefcase from her previous week long travel and time is short. Annette agrees and ITPA provides Annette with turn-by-turn directions so that she pulls into her space three minutes later for a short one minute walk to the waiting train.

Leaving her parked car, Annette asks ITPA to remind her of the car's location on the return trip and that a new store with Middle Eastern merchandise has opened next to the smart parking garage and they might have a perfect gift for that anniversary. ITPA records the information and schedules it to be reported back to Annette at least once between work appointments throughout the day and before Annette is scheduled to leave work at 5:00 PM that afternoon and again 10 minutes after the work departure. ITPA had confirmed there was room on the train and prepaid the Tri-Rail ticket just as she boards the train. Because the ITPA updates and alerts Annette automatically, there was no need for her to fumble with buttons while she's driving. She knows she can trust the system and feels safe in using it.

On the train, Annette finishes her review of the recent weird weather reports and emails her colleagues regarding important issues to be discussed at the noon lunch. ITPA waits for Annette to finish her email and in the minutes before Annette arrives at the Miami International Center station, it informs her that the university express bus service that will take her to the university departs in 10 minutes. Annette uses the time to call her office to confirm the multimedia arrangements that need to be available during the lunch appointment and to drink her second and last cup of coffee for the day.

On board the bus, Annette visits with two colleagues from the university's Engineering School who routinely commute to work via Metrorail and the express bus service. They both travel from South Miami to the Miami Intermodal Center and then connect to the express bus service for the final leg of the 40 minute commute. Annette uses the time with them to “test drive” her lunch presentation and catch up on the news about mutual friends from college and important family matters. They agree they no longer see each other as often as they would like and agree to visit again at the University Retreat scheduled in Palm Beach County two months hence. ITPA is asked to coordinate their travel arrangements.

The express bus drops Annette on the north side of the Main Campus and she arrives at work 40 minutes faster that Bob, who was traveling in the car next to Annette just as she pulled off 1-95 at the Sheridan Street exit in Hollywood, Fla. Despite ITPA advice, he stayed on southbound 1-95 and used westbound S.R. 836 to travel by car all the way to the same University destination. He needed his car for a trip to Naples later in the day.

Annette's assistant greets both Annette and her first appointment at the office reception area at 9:00 AM sharp. Annette is refreshed and no longer frustrated.

The Rushed Student—Francisco, an honors college sophomore, is so focused on exams, studying, after school activities, paying his rent, and that girl he met last night at the all night diner up the street that he forgets to leave on time for a critical final exam. He only lives a short drive from campus, but he knows that finding a parking spot at school could be the longer part of his trip. He could take his bike or walk if he had more time and if it was not raining heavily. ITPA alerts him that with the rain the streets are clear of any heavy traffic.

Francisco is late, so he quickly requests ITPA to reserve for him a parking spot in the smart parking garage. Upon arrival, Francisco immediately parks his car in the reserved space; not only did he make it to school on time for his final exam but he also saved 20 minutes and the gas he would have used trying to find a parking spot.

The Hard-Working Immigrant Father—Jose, a South Florida resident, is focused on providing a comfortable home for his family. He is new to the residential area 20 blocks to the north of the university. He rented a very small apartment for himself and his three sons and works two jobs to barely make a comfortable living. His children are doing excellent in the local STEAM high school, and he likes the local community transit and streetcar service that take them to a local college for additional English language courses and advanced mathematics classes not available in their high school. He saves money wherever he can and car ownership is not an option.

In the evening he uses the local community transit to get to the university express bus station when traveling from home to his first job east of the Miami Intermodal Center (the third shift at a furniture manufacturing plant, that starts at 12 midnight and ends at 8:00 AM) and he completes his reverse commute by taking the morning university express bus to his second job just a few blocks from where he lives (a short three-hour janitorial shift at a local early hours nightclub).

Jose had been a mechanical engineer in his native county and came to America a year ago when his wife died and neighborhood violence in Guatemala City became an everyday concern. With his limited language skills, these jobs were the best he could find. His language skills are improving; as his children are taught to be proficient in English, they teach him. During his walks along the tree-lined neighborhood streets and City Hall Square, he tries out his broken English on people he meets.

He is excited about a new transportation gateway and hub being constructed just north of his neighborhood because it will provide an easy three block walking access to the complete regional transit system via express buses to the Miami Intermodal Center. This new multimodal facility re-enforces his decision for buying the “IPTA Family Plan” annual pass so that his entire family can use the ITPA to manage their transit travel. The ITPA usage was especially important to Jose's youngest some who has a hearing impairment. ITPA remembers the condition as explained by Jose when the Family Plan was purchased and provides his son with more frequent text advise and vibrating message notice as well as an advisory to the transit vehicle operator that shuttles Jose's youngest son to school. This gives Jose the peace of mind that Jose will get timely travel advice and that those who drive the transit vehicles know the nature of his son's disability in case there is a problem.

With the money they save, he thinks that in a few years they will be able to afford a larger home, while still saving for college and partaking in an occasional sporting or cultural event at the university. Getting a car has never been a priority because ITPA and mass transit fits well with all the travel needs for Jose and his children and he prefers to spend his limited funds on quality education and better housing.

At the local diner, when he talks to his friends from work that always drive from place to place (something he knows is a waste of time and energy), he encourages them to use the ITPA and transit improvements instead. He explains how it helps him to save money and create a high quality, yet affordable lifestyle for their family. They joke and call him “ITPA Jose”. He laughs and in good humor calls them “stupid gringos”. When he pays for everyone's coffee using his new smart phone application, they begin to notice. After Jose leaves the diner, the youngest of the group the remains says: “That “ITPA Jose” may have a point; with his access to the newest technology and transit, he has all he needs for convenient transport right in his pocket.

Jose's upstairs neighbor at the apartment complex is the rich developer. When he rented to Jose the small apartment, he was the one who convinced Jose that the ITPA and the transit system it supports was the most advanced intelligent transportation system in the world and that therefore the prospects for economic growth were very good. Their kids play soccer in the town's youth league and the developer informally gets mechanical engineering advice from Jose from time to time. Lately, the developer has been introducing Jose to his friends.

As Jose gains confidence and community stature, he convinces his local friends one by one to use ITPA and the mass transit options it recommends so they too can confidently make safe, interesting, affordable and convenient trips using mass transit, bicycles, and walking as preferred modalities. Jose is proud to be an important part of this Southeastern Florida community that is growing more prosperous each and every day.

### SUMMARY OF THE INVENTION

A method of informed, multi-modal travel via one or more potential routes to a defined destination includes (a) using real-time travel-related data relative to one or more inputs of present traffic flow, emergency events, roadway construction, special community events, weather, historic traffic-affecting trends, and parking conditions at an informed traveler's destination; (b) providing at least one output of said using Step (a) applied to a historical database, of at least said output of Step (a); (c) generating a spatial analysis of real-time traffic flow and other transit data; (d) applying predictive and analytic models having rule-based constraints to selective outputs of said Step (a) and said Step (c); (e) confirming authorized users of the present method by identity confirmation and management thereof; and (f) providing user and management wireless access portals to the informed traveler.

The method of providing traveler guidance to a pre-determined destination in a multi-modal transit network may also include the method comprising:
1) Establishing a database including a matrix of daily routes of category A trains, inclusive of times of day at each station or stop thereof, said stations or stops within a commutable distance of said pre-determined destination, said trains including any mode of long distance passenger trains, regional commuter passenger trains, and metropolitan fixed-guideway-transit
2) Establishing a database including a matrix of daily routes of category B trains and Category B express buses having routes that include a station or transfer point of intersection within the route of at least one of said category A trains, the stops and stations of said category B trains and express buses within said commutable distance of said destination
3) Establishing a database including a matrix of daily routes of local buses or community transit vehicles C within said commutable distance of said destination and providing that said distance shall not to exceed two miles, at least one of said routes having a stop, station or transfer point of intersection with at least one of the routes of said trains of Category A or trains and express buses of category B
4) Monitoring traffic conditions upon major road arteries within said commutable distance of said destination
5) Monitoring events of actual and prospective vehicle congestion, by sector, upon said major arteries within said communicable distance, and generating wireless alerts to travelers when definable actual or prospective vehicle congestion occurs or is likely to occur within a one hour time frame
6) Generating, for use by actual and prospective enroute travelers on said major arteries, suggestions of alternative routing by transferring to a train station of said category A or B trains, or express bus routing to said destination, by electronically overlaying or querying said matrices of said databases regarding the schedules of category A trains, category B trains or express buses, and said local buses or community transit vehicles C for the final up to two mile trip segment for the designated destination, to determine stops or stations thereof in the vicinity of the traveler upon the said major artery, permitting the traveler, should he wish, to park his vehicle and, within a user acceptable timeframe, board a train or express bus and, as necessary, thereafter board a second train or express bus and local buses or community transit vehicles to more efficiently reach the pre-determined destination
7) Providing specific guidance as to timing allowed for and directions during intermodal transfers.
8) Steering personal information and medical conditions of ITPA customers so that can be considered in the formulation of predictive information provided to the traveler and regarding transportation choices

An object of the instant transportation information system provides benefits of a basic Intelligent Transportation System (ITS) with the benefits of a modeling system the predicts traffic conditions in one or more hours before they occur such that it can advise the ITPA users how to make optimum use of the existing transportation capacity through large-scale Transportation Demand Management (TDM) strategies. When applied to a multitude of individual informed travelers, the need to build additional highway capacity is reduced and the ridership and customer revenues of mass transit are increased.

Another object is to significantly reduce traffic congestion, which costs U.S. commuters 4.2 billion hours and 2.8 billion gallons of fuel each year, costing the U.S. economy up to $200 billion per year.

A yet further is to reduce congestion by as much as 20 percent or more.

A further object is to enable transportation agencies to collect real-time data needed to measure and improve the performance and capacity of the transportation system by the least expensive means possible, making ITPA the centerpiece of efforts to reform surface transportation system and hold providers accountable for results.

A still further object is to use advanced information technology platforms, ITS, predictive modeling systems, specific traveler interests and needs, and smartphone-based software, the ITPA, to substantially reduce: vehicle miles traveled; greenhouse gas (GHG) emissions; and, travel time, costs, and stress.

Another object is to provide to transportation system managers an expert transportation information system planning tool that identifies locations where, despite the operation of the ITPA, traffic bottlenecks in fact still occur so that they can better conceptualize how best to add multimodal transportation capacity in the future by projecting the existence of alternative multimodal improvements and determining on a scenario basis which alternative performs best in optimized traffic conditions through benefits and costs analysis.

The above and yet other objects and advantages of the present invention will become apparent from the hereinafter set forth Brief Description of the Drawings, Detailed Description of the Invention and Claims appended herewith.

### BRIEF DESCRIPTION OF THE DRAWINGS

FIG. 1 is a conceptual flow diagram of the ITPA architecture

FIG. 2 is a conceptual illustration of the hardware and databases with which the ITPA of FIG. 1 are implemented.

FIG. 3 is a flow diagram of basic ITPA algorithm.

FIG. 4 is a list of Spatial Analysis Issues.

FIG. 5 is a list of functions of the Smart Garage.

FIG. 6 is a list of Predictive Databases and Algorithms.

FIG. 7 is a list of Identity Management Issues.

FIG. 8 is a list of ITPA portals.

FIG. 9 is a list of System Security and Access Issues.

### DETAILED DESCRIPTION OF THE INVENTION

An important ability of the ITPA is enhanced situational awareness such that large-scale TOM is achieved—having advanced knowledge and awareness of actual and likely conditions along potential travel routes and the capacity, through individual traveler decisions, to optimize transportation system capacities. This “situational awareness” is the capability for a traveler to be informed of situations in time and space from multiple perspectives in order to determine how much alternate trip choices will impact travel time and costs and to more frequently make multimodal and other transportation choices by removing scheduling guesswork, especially when shifting from one mode to another.

Broadly speaking, situational awareness has been described as: “the perception of elements in the environment within a volume of time and space, the comprehension of their meaning (particularly when integrated together in relation to the operator's goals), and the projection of their status in the near future. TOM has been broadly defined as: “the applications of strategies and policies to reduce travel demand, especially that of single-occupancy private vehicles, or to redistribute this demand in space and time.”

Many of these situations include everyday challenges such as routine rush hour traffic congestion and safety issues arising from stop-and-go rush hour traffic or traffic congestion and safety issues that specifically arise from emergencies such as accidents, weather, events such as sporting events or concerts, construction, government notifications (e.g., specific convoys or processions), parking information, or commercial notifications (e.g., special oversized freight movements). Provided is the groundwork for advanced situational awareness and large-scale TDM by engaging in the use of historic traffic data, research and the further development of best methods for data integration and analysis of the following situational data:
1) Detailed maps, routes and driving directions
2) Regional express bus, fixed-guideway transit, and train schedules (regional mass transit) between residential communities, universities, multimodal centers, international airport, seaports, major regional destinations and job centers
3) Airline, regional or local waterborne transport, and passenger ships schedules
4) Transport capacities by common carriers providing services in, to or from the region
5) Real-time location and actual and projected arrival/departure times for regional mass transit, airline, regional and local waterborne transport, and passenger ships
6) Real time traffic congestion information (rush hour or otherwise) on limited access highways, major roadway arterials (4 lanes or more), and identified local street determined by transportation system managers to be useful for regional travel as shortcuts or alternate routes as between limited access highways and major roadways arterials as well as around frequently congested highway and arterial segments 7) Intermodal timing estimates for movements as between specified locations on limited access highways, major roadway arterials, identified local streets, and the immediate access points for regional mass transit, airline, regional or local waterborne transport, and passenger ships 8) Smart parking garage information as to location of available parking spaces or reserved parking opportunities 9) Information that is confidentially retained by ITPA as to transportation preferences provided by the individuals who purchase the ITPA service to help optimize the ITPA users' trips 10) Information provided by ITPA sponsors who are featured as useful alternate business or other destination and broadcasted to ITPA users when needed to fulfill a travel requirement or need

All transportation and related data is updated at the most frequent intervals available. This capability provides the system with the information needed to keep ITPA users up to date on information that will affect their travel and make intelligent recommendations to ITPA users as detailed below.

Travel suggestions and options are an important part of keeping ITPA users informed about their travel choices and to provide route-related recommendations based on identified traveler preferences. Such recommendations inform a traveler of options that may alter the traveler's plans. These suggestions are based on the analysis of multiple situational awareness elements and may involve a specific action related to travel departure times, a change in a traveler's planned route or destination, and a change in transportation modes to be used for all or part of a trip. They are sometimes used in conjunction with routing guidance. Recommendations can include the following:
1) Delay travel for a specified period of time (e.g., leave in 10 minutes or to avoid traffic congestion delay departure by 90 minutes to achieve the same result)
2) Reroute planned travel via an automobile (e.g., take local streets instead of a congested limited access highway or major arterial roadway)
3) Take regional mass transit for part of or the entire route to the planned destination (i.e., highways are congested, but a specific regional mass transit option or options will bring the traveler to the same destination)
4) Select an alternate destination that will achieve the same result (i.e., a different airport and airline connection or a different shopping center and similar restaurant)

One example is to inform a traveler that given a travelers planned route and current situational awareness information, a typical delay for automobile transportation along the planned route is 75 minutes while the delay for public transport is likely to be 15 minutes. If requested, ITPA could also estimate costs likely to be incurred for each transportation choice that is available (i.e., cost to travel by private vehicle versus cost of regional mass transit and any parking costs).

The system might recommend taking public transportation in this case, and provide information and routing guidance that include regional mass transit information (e.g., which trains, fixed-guideway transit or express buses to take and their likely departure time). This capability uses rules, analyses and predictive statics to calculate a recommendation. At first, travel suggestions will be limited to the regional routes and destinations described in the situational awareness discussion above for which situational data is available.

The ITPA capacity involves routing instructions and guidance, including providing the traveler with alternative travel information and routing instructions based on the traveler's plans, smart parking, situational awareness for CCTVs and the like. For example, as ITPA anticipate congested roadways ahead, it would recommend alternative highway, arterial and street routes, identify locations of regional mass transit stations, and confirm the ticket availability for boarding on such regional mass transit alternates. Importantly, when routing is requested, the system will also specifically include an analysis of available data regarding likely return trip conditions based upon time of day and reminder of any car park location used. The ITPA user will be given an opportunity at that time to make return trip plans and arrangements or to defer the decisions until later in the day.

This provides ITPA users with more viable options; particularly in terms of the availability of regional mass transit (e.g., is regional mass transit available at the expected time for the return trip and what is cost including parking your car in one location compared to another). If the recommended return trip is not desired by the ITPA user, a different return choice would be identified. Return trip reminders will be sent to ITPA user as desired during the day.

Routing guidance includes a historic and predictive analysis of situational data for major routes when available. If neither real-time, historic, nor predicted data is available, then users are provided with, at minimum, turn-by-turn routing guidance similar to what is available in standard navigation devices.

Initial phase deployment of ITPA would provide for at least: ten regional destinations; five destinations identified by the ITPA user; 30 local streets selected to match with specific local destinations; 25 limited access highways and major roadway arterials; six regional mass transit options; two airports with their flight information, two seaports with their passenger ship and other water borne passenger transport itineraries; and, five common carriers with their passenger transport capacities.

Prototype Architecture

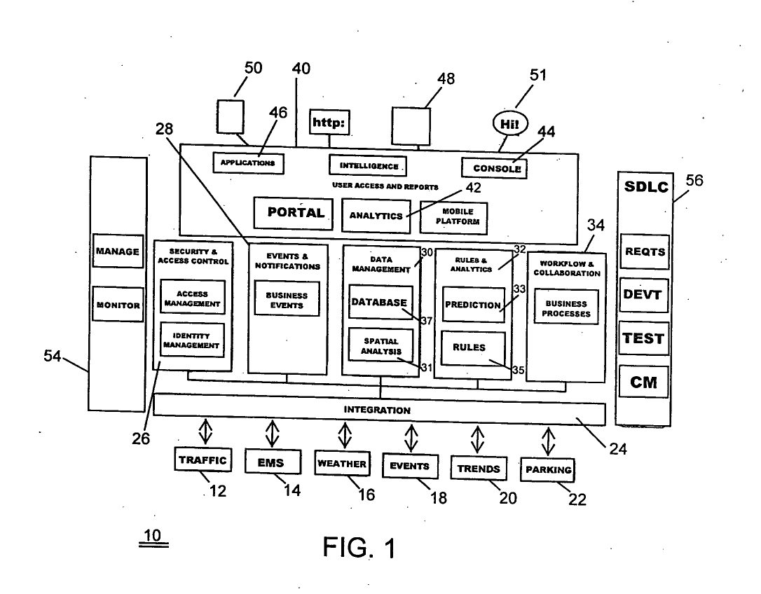

To create the innovative ITPA system and software, assets already in use around the world are combined with intelligent transportation and business analytics, spatial analytics, and other components as suggested by the ITPA architecture shown in FIG. 1.

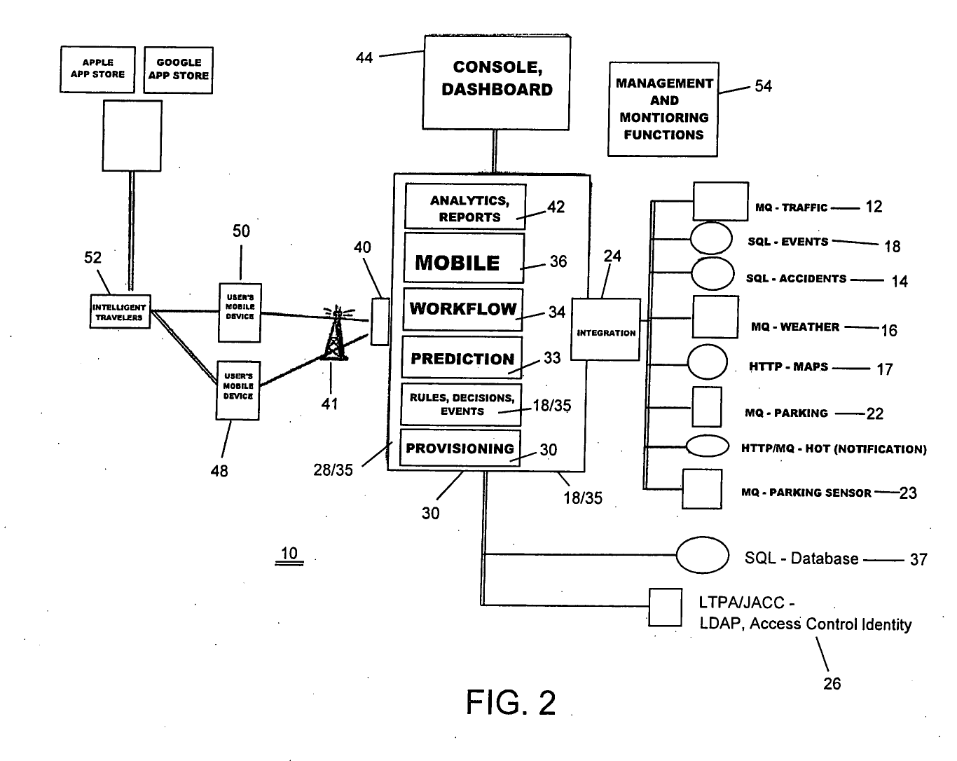

More particularly, shown in a ITPA system 10 of FIGS. 1 and 2 are an input 12 relative to traffic density expressed by sector and artery, input 14 relative to accidents expressed by sector and artery and other EMS events, weather conditions 16, community events 18, historic trends 20 related to any of the above, as well as inputs 22 relative to monitoring and reservation of parking, and a parking sensor 23 (see FIG. 2), at the intelligent parking garage at the traveler's destination. These inputs are all integrated at data buss 24, shown in FIG. 1.

Selectively integrated information is then directed to five processing areas, namely, security and access control unit 26; events and notifications 28; a data management unit 30 which includes spatial analysis 31 and a supporting database 37; rules and analytics 32 which includes a predictive function 33 and system rules 35; and a workflow and collaboration module 34.

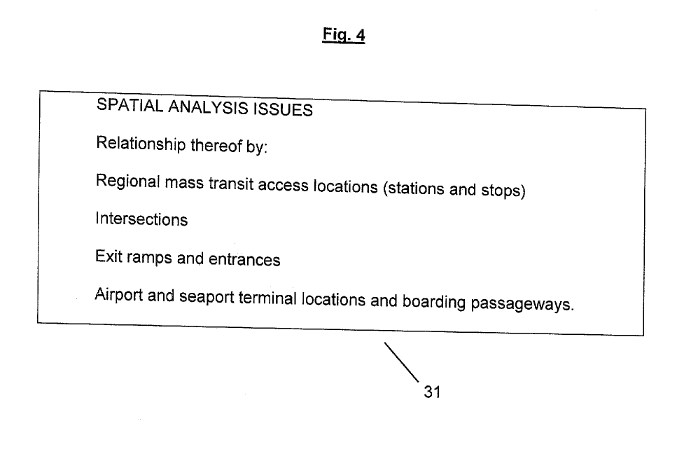

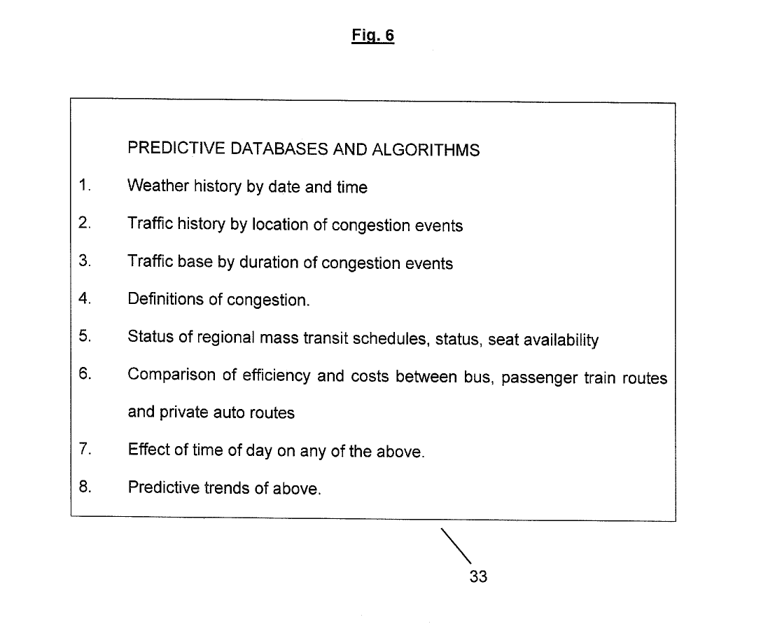

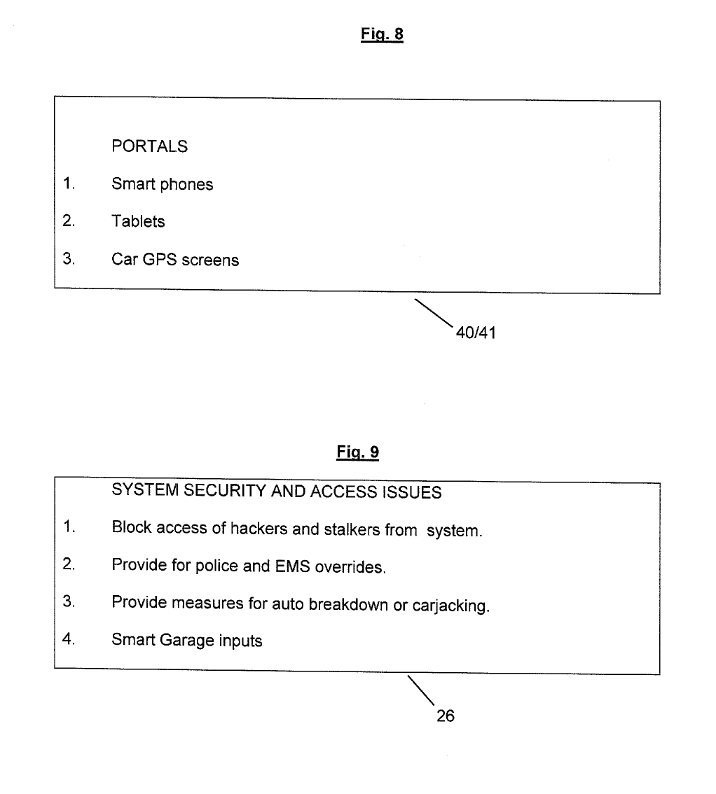

Mobile monitoring 36 is shown in FIG. 2 which may provide inputs to spatial analysis module 31 of the data management unit 30 shown in FIG. 1. The spatial analysis issues are enumerated in FIG. 4, while the various predictive capabilities of function 33 are listed in FIG. 6. External portals 40 including wireless tower 41 are shown generically in FIG. 2 and set forth in FIG. 8 which, namely, include interfaces with smart phones 48, tablets 50, an Internet link 51 via a personal computer and other computers or computing system servers, and car GPS system. Only certain portals will be accessible to particular users. A higher level of analysis which includes reports 42 is shown in FIGS. 1 and 2. For example, there are shown a Smart phone 48 and tablet 50. Further, intelligent travelers 52 may access the ITPA through said Internet link 51 to the personal computer, other computers or computing system server, while 51 may be a car GPS system.

Further shown in FIGS. 1 and 2 are management and monitoring functions 54 as well as utilities 56 which include special requests, development issues, test modes and a control module CM.

In FIG. 4 are indicated the spatial analysis issues addressed by the system, which may be categorized in terms of physical sectors covered by the ITPA at key intersections, exit ramps and road entrances as well as regional mass transit, airport, seaport and common carrier access locations and other two- or three-dimensional information which may be provided to spatial analysis module 31 (see FIG. 1).

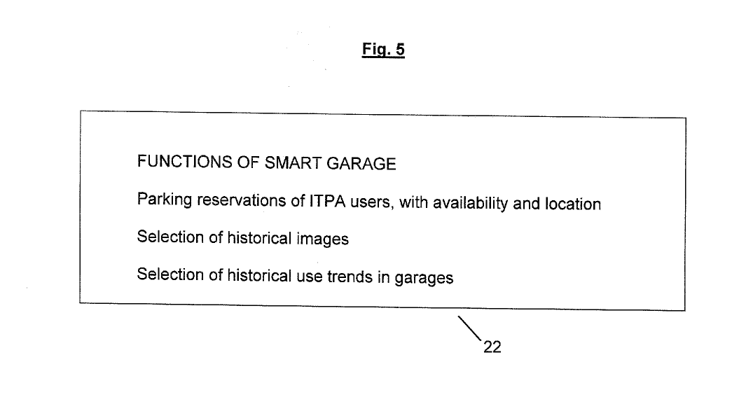

FIG. 5 summarizes the functions 22 of the smart garage of the system, namely, providing reservations to ITPA parking spaces within the garage, advising others in the garage of such reservations, advising ITPA users of current parking availability and its general locations, maintaining a record of historical traffic flow patterns within the garage and of historic trends in garage usage inclusive of ITPA usage of the garage.

FIG. 6 provides a summary of the predictive databases and algorithms which function 33 (see also FIGS. 1 and 2) will include or consider, these including weather history by date and time, traffic history by sector of congestion, traffic histories by duration of congestion, definitions of congestion in terms of impact upon total trip, regional mass transit issues (i.e., schedules, on time status, estimate station arrivals, and seat availability, comparison of efficiency between private automobile transport, regional mass transit service within a region of interest, effect of time of day on any of the foregoing, estimated cost comparisons, traveler identified immediate travel destinations and those additional destinations to be included in trip planning over time, and predictive trends which may be derived from any of the foregoing.

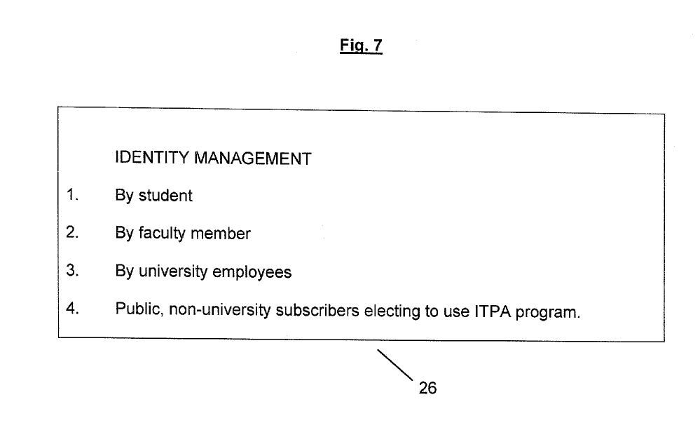

In FIG. 7 is shown a list of identity management issues 26 to assure user integrity of the ITPA system. Such identity management will be specific to student, faculty member, education employee and public, non-university subscribers of the system, and each will provide a confirmation means requiring user response upon a spot checking of the identity of system users. It is to be understood that the present invention is not limited to a university environment or a university-target location.

In FIG. 9 are listed system security and access issues of unit 26 that are considered in the design of the ITPA, namely, that of blocking access to the system hackers and stalkers; providing for police and EMS overrides; providing measures in the event of an auto breakdown or carjacking; and providing necessary inputs to the smart garage as, generally, are indicated by said inputs 22 and 23.

Prototype Operational Environment

ITPA server components are, at first, installed on hardware and software running in a laboratory environment. This environment will provide a flexible and robust enjoinment that will allow for the analysis and development of the most appropriate, scalable hardware and networking designs specs and configurations to support the larger, production systems in later phases. Support will be provided for a small number of users in this phase.

Prototype Project Plan and Schedule

A more detailed plan describing the roles/responsibilities of the various experts and organizations, specific schedules and milestones, project deliverables, operational environment, user types and numbers. This develops naturally from the diagram of FIG. 2 herewith.

The ITPA Prototype Research and Development Phase also involves a university centric prototype technology development focused on investigating, determining, and demonstrating the best way to create an ITPA that will help university-affiliated subscribers and those from an adjoining community to travel to and from the university faster, easier and more enjoyably. As shown in FIGS. 1 and 2, this phase will focus on four primary capabilities:
1) Smart Parking use and integration
2) Real time situational aware data integration from multiple, heterogeneous sources
3) Travel suggestions
4) Predictive guidance based on situational conditions such as traffic congestion, on-route accidents and the like

Prototype Primary Capabilities

Smart parking is an important component of the ITPA. As travelers near their destination, for example, a university, they will receive information on their mobile device indicating the location of available parking in designated smart garages. The system will provide real-time information to university-affiliated subscribers regarding the availability of parking spaces within the university's Smart Garages. The first iteration will include likely parking by availability by garage as well as in future enhancements delineating locations of parking spaces available by floor and/or by quadrant and for specific reserved parking spots.

Advanced Reservations

Reserved parking will also be a part of the system for those ITPA travelers willing to pay a premium. At any smart garage, a limited number of metered parking spaces will be specially equipped with a wireless detection system and electronic signage with a siren. The sign will indicate that the space is reserved by displaying either the name of the subscriber for whom the space is reserved or a reservation number.

An alarm will sound if anyone else parks in the space. As soon as the space is reserved by the ITPA, the electronic sign will begin to display the reservation information to indicate to others not to use the space. The mobile app will then tell the ITPA user which spot to park in. Using the wireless sensor 23 and the user's mobile device 48/50, the system will detect when the appropriate ITP user parks in his space. The system user's ITPA account will be automatically charged, eliminating the need for coins or other payment system.

If a different vehicle enters the space, the system will set of an audible/visual alarm at the space location and notify the violator and parking security that the car will ticketed and towed within a specified time period (e.g., if not immediately, then within 2 minutes or within 5 minutes depending on available security personnel and towing capacity and policy considerations). Pricing for the reserved parking spaces may vary depending on peak availability, demand elasticity, length of stay and whether the user is making a transit connection.

ITPA Localized Pilot Deployment

The Localized Pilot Deployment (LPD) Phase involves the deployment of an operational pilot system that provides all of the features of R&D Phase plus expanded geographic coverage, expanded real-time situational awareness and improved system capabilities for tens of thousands of subscribers. The four primary capabilities will be expanded as follows:

Capability 1—Smart Parking: It is expected that real-time usage information and reservations for parking spaces will be available for at least two garages smart garages for reserved parking and general parking availability notification. Support for other relevant garages will be implemented as they become available for notice of general parking availability and for reserved parking spaced.

Capability 2—Real-time Situational Awareness: Real-time and predictive situational awareness data wherever it is available (e.g., any highway, arterial, street, or mass transit, airport, seaport or common carrier capacity for which information currently exists).

Capability 3—Travel Suggestions and Options: Routes in which travel suggestions will be available will expanded to include all regional mass transit routes and services and other means of public transportation and additional types of information such as weather, major event information (e.g., sporting events), airlines and sea port schedules, real-time departure/arrival information and common carrier information (e.g., Greyhound). Options will be provided to avoid delay or reduce cost.

Capability 4—Routing Instructions and Guidance: Routing guidance will be expanded to include the limited access highways, major roadway arterials, and specific destination-useful local streets, regional mass transit routes and access locations.

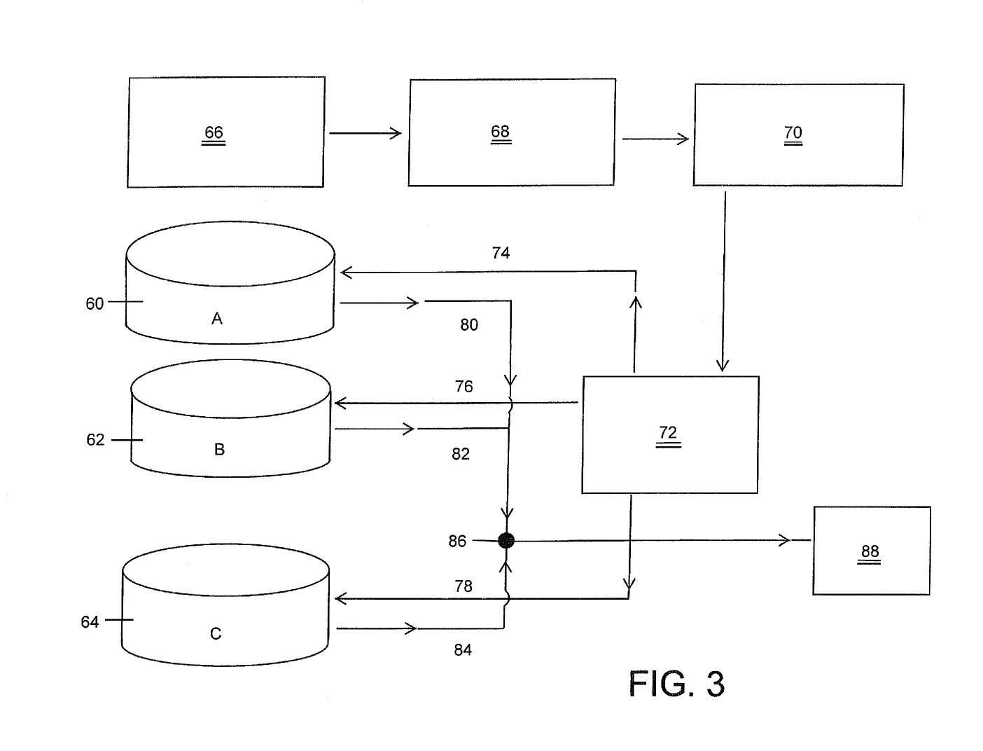

The above may be more fully appreciated with respect to the algorithm flow diagram of FIG. 3 in which is shown a first database 60 which includes 365 days of matrices of daily schedules of category A trains that consists of passenger train or fixed-guideway transit service by time and sector of the stops or stations thereof which are within a daily commutable distance of the destination of the informed traveler.

Indicated at database 62 is one which includes matrices of schedules of all daily routes of category B trains and express bus service having routes which include a station or transfer point common to that of a route of said category A trains, in which the daily routes of category B trains and express buses are stored in said matrices, such routes within a commutable distance of a destination of the informed traveler, and in which the matrices of said databases are of a congruent structure.

There is further established a database 64 which includes matrices of 365 daily routes of Category C community transit vehicles or local buses within a commutable distance of the traveler's destination, each of said routes having a stop, station or transfer point in common with at least one of the routes of said trains of category A or trains and express buses of category B. The structure of said database is congruent to that of databases 60 and 62.

Multi-location traffic sensors 66 upon limited access highways and major roadway arterials, such as video cameras, are used by which a manager 54 may monitor events of vehicle congestion 68 or of other negative traffic impact events such as weather, accidents or special events. To this is added machine recognition of traffic patterns, including image pattern recognition, such as the use of said spatial analysis 31 (see FIG. 4) and predictive function 33 (see FIG. 6), by which a congestion event 70 within a given sector is determined to have occurred or is likely to soon occur

Upon the determination of such an event 70, the IPTA, at step 72, will query all trains and express buses matrices for the particular day, time and sector at which event 70 has occurred, as is shown by lines 74, 76 and 78. Databases 60, 62 and 64 will then respond (lines 80, 82, and 84) by providing time and sector information, inclusive of return trip information, relative to the locations of category A trains, category B trains and express buses, and category C community transit and local buses inclusive of, where necessary, any of the routes of a category A trains, category B trains and express buses or category C community transit and local buses that may intersect (node 86) with each other at a transfer point such that, in combination, the intelligent traveler may more efficiently reach the pre-determined destination, this step indicated at block 88 of FIG. 3.

Such alternate routing suggestions are accompanied by an estimate of costs and time to destination if such alternate routing is accepted by the traveler, versus an estimate of arrival time and costs if one were to simply stay upon the highway, arterial or street and wait-out the period of congestion, which time periods are stochastically predicted based on historical data by predictive function 33 under rules and analytics 32 (see FIGS. 1 and 2) described above. As such, the traveler is able to make an informed decision regarding whether the parking of his vehicle at a station of a category A trains, category B trains and express buses, or category C community transit and local buses would result in a more efficient and cost effective trip to the predetermined destination and whether or not this savings in time or money would be more important that any difference in efficiency regarding the time of return at the end of one's daily schedule at the predetermined destination which of course would include a prediction of traffic conditions at that later time of day.

Regardless of whether any of the suggestions of step 80 are accepted by the traveler, the ITPA system can still permit the traveler to reserve a parking space at the smart garage for a designated timeframe before he continues trip via a major arterial roads to the destination (e.g., delay trip while undertaking other activities useful to the informed traveler are undertaken.

The system thus inherently introduces a new capability: Alerts which involve the ability to provide to the traveler alerts and notifications of information relevant to the traveler's planned route that may indicate a change in travel time, or a change in routing recommendations and guidance instructions. Alerts are generally triggered by a change in conditions along a traveler's route based on situational awareness data and analysis of the effects. For example, if a traveler's route includes riding on a public transit bus, the traveler could be alerted if the bus schedule or event changes that would increase travel time. If desired, this could be coupled with new routing recommendation and alternate guidance instructions that would potentially decrease travel time and impact trip costs (assuming such a change is available).

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

We claim:

1. A method of informed, multi-modal travel from one or more potential routes to a defined destination, the method comprising the steps of:
(a) using real-time travel-related data relative to one or more inputs of present traffic flow, emergency events, special community events, weather, historic traffic-affecting trends, and parking conditions at an Informed traveler's destination;
(b) providing at least one output of said using Step (a) to a historical database;
(c) generating a spatial analysis of real-time traffic flow and other transit data;
(d) applying predictive and analytic models having rule-based constraints to selective outputs of said Step (a) and said Step (c);
(e) confirming authorized users of the present method by identity confirmation and management thereof; and
(f) providing user and management wireless access portals to the informed traveler.

2. The method as recited in claim 1, in which using said traffic conditions of said Step (a) and spatial analysis of said Step (c) include use of CATV cameras positioned upon roads, railroads and interactions, police and transportation departments advisories to the public regarding traffic conditions along the respective routes of the informed traveler.

3. The method as recited in claim 2, further comprising:
providing said suggestion to a cell phone and an application therefor.

4. The method as recited in claim 1, in which said predictive models of said Step (d) include deviation from historic travel advisories regarding traffic or construction-related delays.

5. The method as recited in claim 4, in which said advisories include suggestions for alternatives to use a private vehicle, re-routing of use of a private vehicles, delayed departure in the use of private vehicles or alternative public transportation to ameliorate actual or predicted traffic congestion issues.

6. The method as recited in claim 2, further including:
providing of text and video information and intelligence upon which predictive advice to the informed traveler may be based, thereby furnishing a necessary situational awareness of relevant travel-related factors.

7. The method as recited in claim 1, in which said predictive models incorporate safety considerations thereinto regarding security of public versus private transportation at given times of the day and in or through particular neighborhoods.

8. The method as recited in claim 5, further comprising:
providing a cellphone of informed traveler with a GPS, the location of which is continually monitored as a part of said Step (a) above.

9. The method as recited in claim 5, further comprising:
sounding an alarm or alert if an unauthorized vehicle parks in a parking space or slot of a parking garage associated with the present method.

10. The method as recited in claim 5, further providing:
a management console in a communication center through which emergency overrides and community messages or events of importance can be communicated to the informed traveler.

11. The method as recited in claim 5, further comprising:
imposing a rule and protocol regime to said Steps (a) through Step (f) above.

12. A method of providing traveler guidance to a pre-determined destination in a multi-modal transit network, the method comprising:
(a) establishing a database including a matrix of daily routes of category A trains, inclusive of times of day at each station or stop thereof, said stations or stops within a commutable distance of said pre-determined destination, said trains including any mode of passenger trains and fixed-guideway transit;
(b) establishing a database including a matrix of daily routes of category B trains and category B express buses having routes that include a station or transfer point of intersection within the route of at least one of said category A trains, the stops and stations of said category B trains and express buses within said commutable distance of said destination;
(c) establishing a database including a matrix of daily routes of local buses or community transit vehicles C within said commutable distance of said destination, at least one of said routes having a stop, station or transfer point of intersection with at least one of the routes of said trains of category A or trains and express buses of Category B;
(d) monitoring traffic conditions upon major road arteries within said commutable distance of said destination;
(e) monitoring events of actual and prospective vehicle congestion, by sector, upon said major arteries within said commutable distance, and generating wireless alerts to travelers when definable actual or prospective vehicle congestion occurs; and
(f) generating, for use by actual and prospective enroute travelers on said major arteries, suggestions of alternative routing by transferring to a train station of said category A or category B trains or express bus stations to identify the best train or express bus route to said destination, by electronically overlaying or querying said matrices of said databases regarding the schedules of category A trains, category B trains or express buses, and said local buses or community transit vehicles C, to determine stops or stations thereof in the vicinity of the traveler upon the said major artery, permitting the traveler, should he wish, to park his vehicle and, within a user acceptable timeframe, board a train or bus and, as necessary, thereafter board a second train or express bus to more efficiently reach the pre-determined destination.

13. The method as recited in claim 12, further comprising:
(g) establishing a database of traffic-congestive events to stochastically predict a mean delay for a given road location at a given time of day to provide to auto travelers suggestions relative to a delay of the time of their departure.

14. The method as recited in claim 12, in which a public safety factor comprises a congestion event.

15. The method as recited in claim 12, in which a weather factor comprises a congestion event.

16. The method as recited in claim 12, further comprising:
within a parking garage at the pre-determined destination, enabling a traveler thereto to reserve a parking space, or a space within a dedicated parking zone, for a selected timeframe upon a particular day of travel.

17. The method as recited in claim 16, further comprising:
providing notification, as by electronic audio or visual means, that a given space within said garage has been reserved by a traveler using the present method.

18. The method as recited in claim 12, further comprising:
considering of a personal information medical condition of an informed traveler in formulation of predictive information provided to the traveler and transportation choices offered the informed traveler.

19. The method as recited in claim 12, further comprising:
producing analytic reports to attempt to quantify the amount of time saved by each traveler through use of traffic congestion avoidance advice and use of alternative public transit when suggested by the method.

20. The method as recited in claim 12, further including:
providing a management console through which a rule and protocol regime is monitored for compliance, and elements of the steps of the informed traveler method are monitored for purposes of maintenance and functionality thereof.
